(19) United States
(12) Patent Application Publication
(10) Pub. No.: US 2018/0105776 A1
(43) Pub. Date: Apr. 19, 2018

(54) Malting System

(71) Applicant: Moore and More LLC, St Francis, KS (US)

(72) Inventor: Robert Wayne Moore, Westminster, CO (US)

(73) Assignee: Moore and More LLC, St Francis, KS (US)

(21) Appl. No.: 15/293,152

(22) Filed: Oct. 13, 2016

(51) Int. Cl. C12C 1/15

(52) U.S. Cl. CPC C12C 1/15

(57) ABSTRACT

A malting system including at least one vessel coupled to a first fluid flow generator, and coupled to a second fluid flow generator, where the first fluid flow generator and second fluid flow generator generate discrete fluid flows to the vessels to both germinate and dry an amount of material contained in the vessel, where the malting system can further include a plurality of vessels coupled to a plurality of first fluid flow generators, and coupled to a second fluid flow generator, where the plurality of first fluid flow generators operate to discretely generate a fluid flow to a corresponding one of the plurality of vessels.

### I. FIELD OF THE INVENTION

A malting system including a vessel coupled to a first fluid flow generator, and coupled to a second fluid flow generator, where the first fluid flow generator and second fluid flow generator generate discrete fluid flows to the vessel to discretely germinate or dry an amount of grain contained in the vessel, where the malting system can further include a plurality of vessels each correspondingly coupled to one of a plurality of first fluid flow generators, and coupled to a second fluid flow generator, where each of the plurality of first fluid flow generators operate to discretely generate a first fluid flow to a corresponding one of the plurality of vessels to germinate an amount of grain therein, and where the second fluid flow generator operates to discretely generate a second fluid flow which can be directed between each of the plurality of vessels to dry an amount of grain therein.

### II. BACKGROUND OF THE INVENTION

One of the ingredients used to brew beer is malt, which is grain that has undergone a process of steeping, germination, kilning, and roasting. Depending on the parameters of the process, such as temperature and relative humidity for germination, the kilning temperature, and the heating process of roasting, a brewer can produce various forms of malt for use in making beer. Brewers typically buy malt produced by an entity other than the brewery, thereby limiting a brewer's ability to produce his own malt or to alter the quality and characteristics of the malt used in his beer. There would be an advantage in providing a malting system and a method of making and using a malting system useful to germinate and dry amounts of grain according to a brewer's unique specifications to produce numerous and varied malts for use in brewing beer.

### III. SUMMARY OF THE INVENTION

A broad object of the invention can be to provide a malting system, including a vessel, a first fluid flow generator generating a first fluid flow to the vessel at a pre-selected temperature and relative humidity, and a second fluid flow generator generating a second fluid flow at a pre-selected temperature, and further, a malting system including a plurality of vessels and a plurality of first fluid flow generators, each of the first fluid flow generators generating a discrete first fluid flow to a corresponding one of the plurality of vessels, and the second fluid flow generator generating a second fluid flow to the plurality of vessels.

Another broad object of the invention can be a method of making a malting system, including discretely coupling a first fluid flow generator to a vessel, and discretely coupling a second fluid flow generator to the vessel, and further, a method of making a malting system, including discretely coupling a plurality of first fluid flow generators to a corresponding one of a plurality of vessels, and discretely coupling a second fluid flow generator to the plurality of vessels.

Another broad object of the invention can be a method of using a malting system, including disposing an amount of grain in a vessel, fluidicly coupling a first air flow generated by a first fluid flow generator to the vessel for a first duration of time, where the first fluid flow has a temperature and relative humidity to germinate the amount of grain, and fluidicly coupling a second fluid flow discretely generated by a second fluid flow generator to the vessel for a second duration of time, where the second fluid flow has a temperature to dry the amount of grain in the vessel, and further, a method of using a malting system, including disposing an amount of grain in a plurality of vessels, and discretely fluidicly coupling a first air flow generated by one of a plurality of first fluid flow generators to a corresponding one of the plurality of vessels, where the first fluid flow has a temperature and relative humidity to generate the amount of grain in the corresponding one of the plurality of vessels.

Naturally, further objects of the invention are disclosed throughout other areas of the specification, drawings, photographs, and claims.

### IV. BRIEF DESCRIPTION OF THE DRAWINGS

FIG. 1 is a perspective view of a particular embodiment of a malting system.

FIG. 2 is a plan view of the particular embodiment of the malting system of FIG. 1.

FIG. 3 is a front elevation view of the particular embodiment of the malting system of FIG. 1.

FIG. 4 is a first end elevation view of the particular embodiment of the malting system of FIG. 1.

FIG. 5 is a second end elevation view of the particular embodiment of the malting system of FIG. 1.

FIG. 6 is a front perspective view of a particular embodiment of a vessel having the vessel first end wall removed.

FIG. 7 is a rear perspective view of the particular embodiment of the vessel shown in Figure.

FIG. 8 is a perspective view of a vessel coupled to a first fluid flow generator.

FIG. 9 is a perspective view of a first fluid flow generator coupled to a first temperature regulation element, a humidifying element, and associated fluid conducting elements.

FIG. 10 is a front perspective view of a second fluid flow generator coupled to a second temperature regulation element and associated fluid conducting elements.

FIG. 11 is an end perspective view of the second fluid flow generator coupled to a second temperature regulation element and associated fluid conducting elements shown in FIG. 10.

FIG. 12 is a particular embodiment of a controller.

FIG. 13 is a plan view of a second particular embodiment of the malting system having a plurality of vessels having rectangular configuration, each vessel correspondingly discretely coupled to a first fluid flow generator except for one vessel not in use.

FIG. 14 is an elevation view of the second particular embodiment of the malting system having a plurality of vessels having rectangular configuration, each vessel correspondingly discretely coupled to a first fluid flow generator except for one vessel not in use.

### V. DETAILED DESCRIPTION OF THE INVENTION

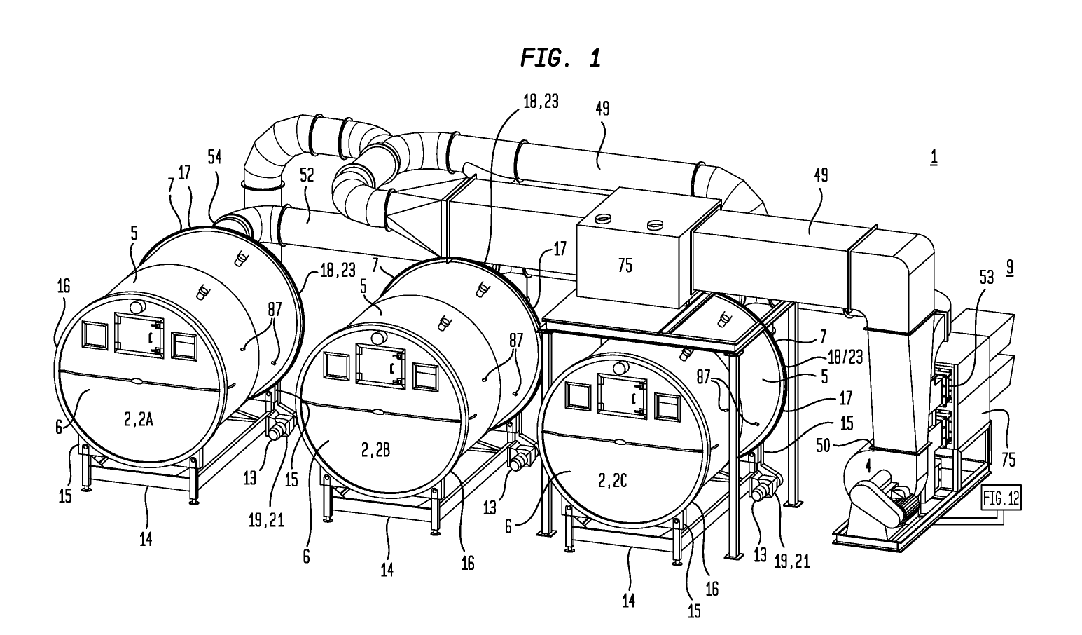

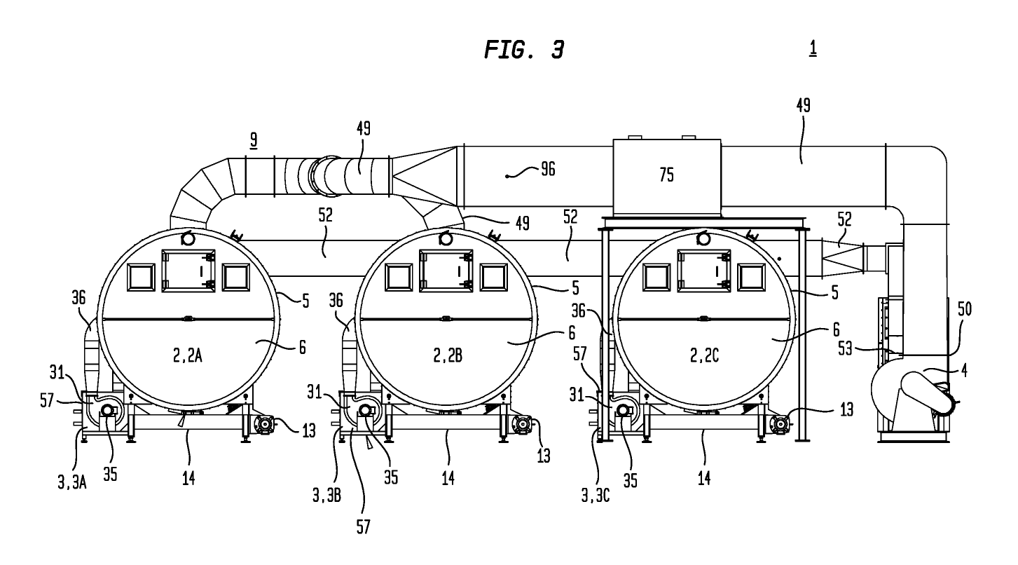

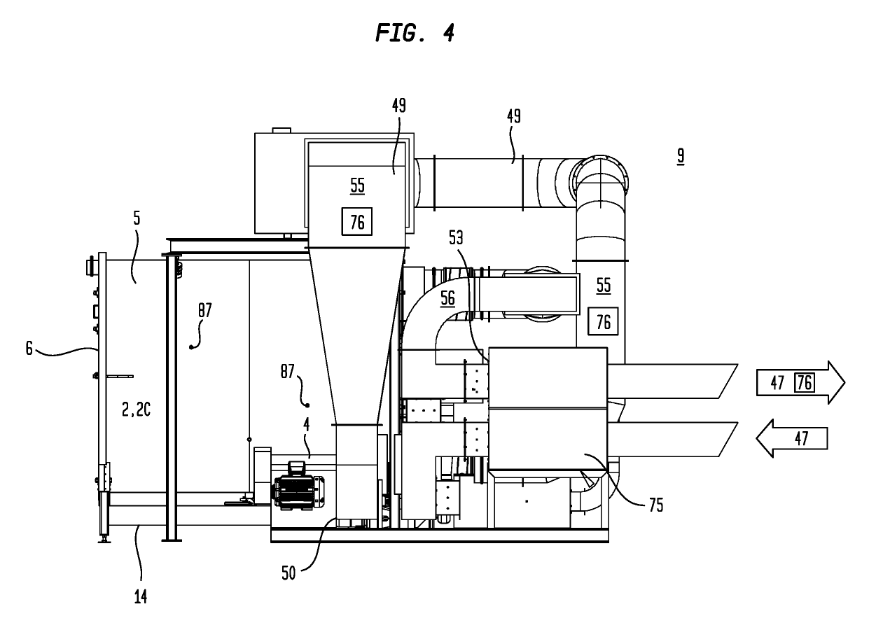

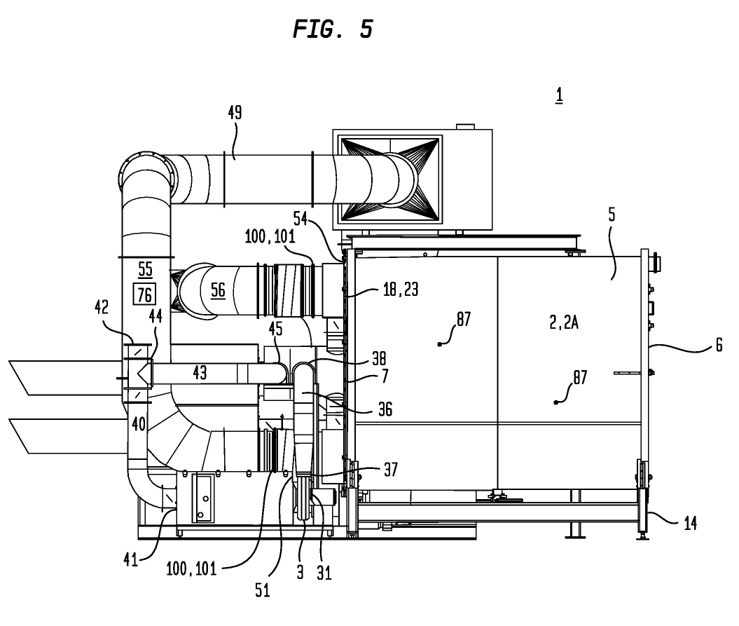

First referring primarily to FIGS. 1 through 5, particular embodiments of a malting system (1) can include a vessel (2), first fluid flow generator (3) discretely fluidicly coupled to the vessel (2), and a second fluid flow generator (4) discretely fluidicly coupled to the vessel (2). For the purposes of this invention, the term “discrete or discretely” means individually separate and distinct.

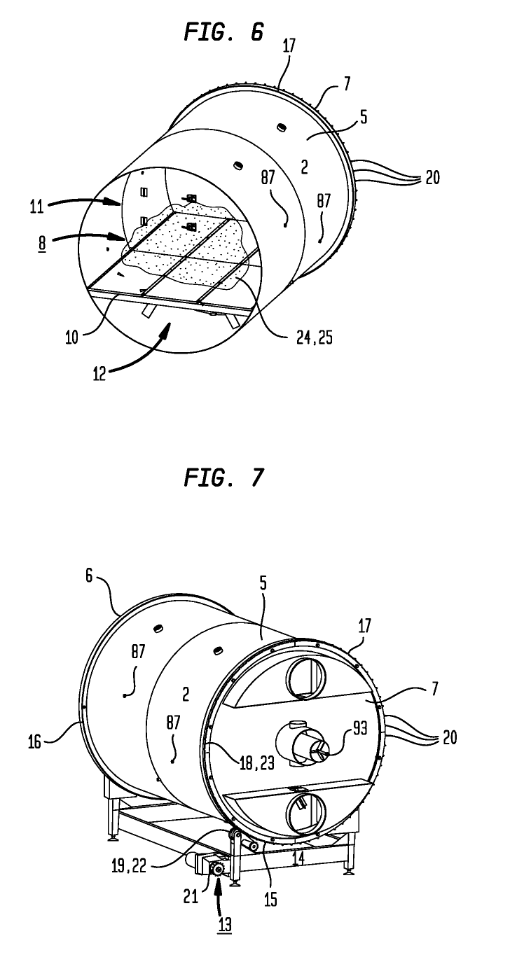

Now referring primarily to FIGS. 6 and 7, the vessel (2) can include a vessel side wall (5) and a vessel first end wall (6) opposite a vessel second end wall (7), joined to define an interior space (8). The vessel first end wall (6) or the vessel second end wall (7) can be removably fastened to the vessel side wall (5) to reversibly seal the interior space (8) of the vessel (2) from the ambient environment (9) surrounding the vessel (2) and to afford access to the interior space (8) inside the vessel (2).

Now referring primarily to FIG. 7, as to particular embodiments, the interior space (8) can, but need not necessarily, be divided by a partition wall (10) to define a material space (11) and a void space (12), which remains empty. The partition wall (10) can be positionally fixed inside the vessel (2) to separate the material space (11) and void space (12), removably positioned inside the vessel (2) to omit the void space (12), or adjustably positionable in the vessel (2) to alter the respective dimensions of the material space (11) and void space (12).

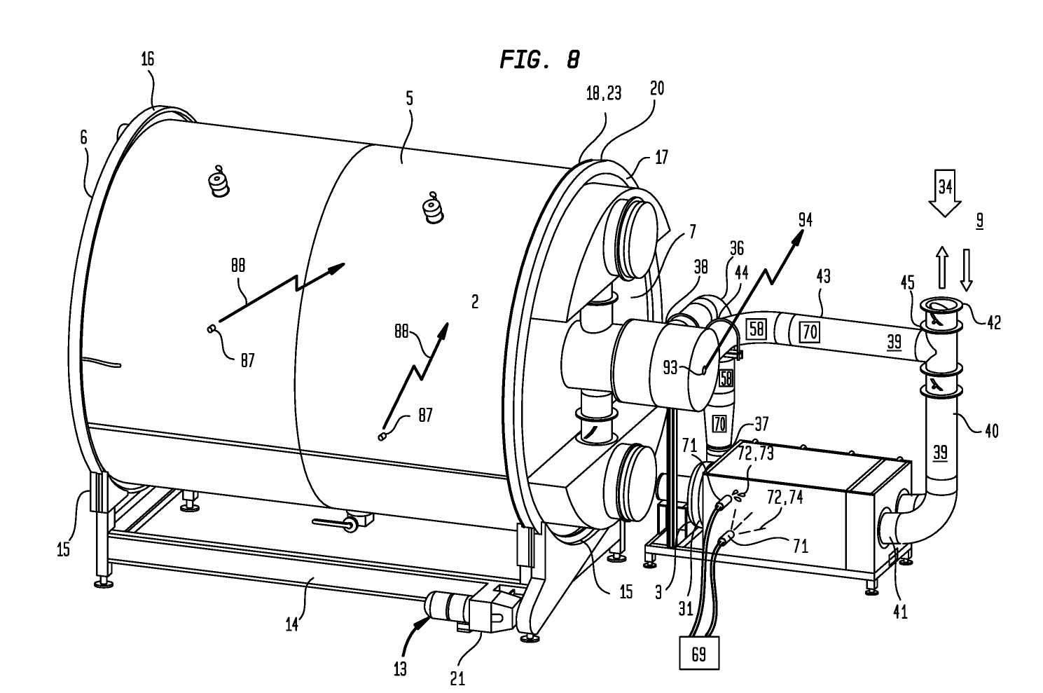

Now referring primarily to FIGS. 7 and 8, as to particular embodiments, the malting system (1) can, but need not necessarily, further include a vessel rotation assembly (13) operable to rotate the vessel (2). As to particular embodiments, the vessel (2) can be rotated in a vessel support structure (14) having roller elements (15) which engage the opposite first and second vessel rims (16) (17) of the corresponding vessel first and second end walls (6) (7). A circuitous member (18) can circumferentially engage the vessel (2) and a rotatable drive member (19). As shown in the illustrative example, the vessel (2) can further include a first plurality of teeth (20) circumferentially disposed in spaced apart relation on the first or second vessel rim (16) (17) (as shown in the example of FIG. 7). A vessel drive mechanism (21) can include a rotatable drive member (19) having a second plurality of teeth (22) circumferentially disposed in spaced apart relation on the rotatable drive member (19). An endless chain (23) can engage the first and second plurality of teeth (20) (22) to rotate the vessel (2) upon corresponding rotation of the rotatable drive member (19).

Again referring primarily to FIG. 7, an amount of material (24) can be disposed in the interior space (8) of the vessel (2). As to particular embodiments including a partition wall (10), the amount of material (24) can be located in the material space (11). In particular embodiments, the amount of material (24) can be an amount of grain (25). For the purposes of this invention the term “grain” means the seeds of a plant and, without limiting the breadth of the foregoing, grain can be selected from the group including or consisting of: barley, wheat, corn, rice, rye, oats, sorghum, millet, buckwheat, quinoa, and spelt, or combinations thereof. The void space (12) can, but need not necessarily, be devoid of any amount of material (24), and excess fluid or other waste produced or generated by the amount of material (24) may collect in the void space (12).

The vessel (2) can have a net load weight capacity as to the amount of material (24) disposed in the interior space (8) of between about 0 tons to about 15 tons. The net load weight capacity can include or be selected from the group consisting of: about 0.1 tons to about 1 ton, about 0.5 tons to about 1.5 tons, about 1.0 tons to about 2.0 tons, about 1.5 tons to about 2.5 tons, about 2.0 tons to about 3.0 tons, about 2.5 tons to about 3.5 tons, about 3.0 tons to about 4.0 tons, about 3.5 tons to about 4.5 tons, about 4.0 tons to about 5.0 tons, about 4.5 tons to about 5.5 tons, about 5.0 tons to about 6.0 tons, about 5.5 tons to about 6.5 tons, about 6.0 tons to about 7.0 tons, about 6.5 tons to about 7.5 tons, about 7.0 tons to about 8.0 tons, about 7.5 tons to about 8.5 tons, about 8.0 tons to about 9.0 tons, about 8.5 tons to about 9.5 tons, about 9.0 tons to about 10.0 tons, about 9.5 tons to about 10.5 tons, about 10.0 tons to about 11.0 tons, about 10.5 tons to about 11.5 tons, about 11.0 tons to about 12.0 tons, about 11.5 tons to about 12.5 tons, about 12.0 tons to about 13.0 tons, about 12.5 tons to about 13.5 tons, about 13.0 tons to about 14.0 tons, about 13.5 tons to about 14.5 tons, and about 14.0 tons to about 14.9 tons, or combinations thereof. The term “ton” for the purposes of this invention means one United States ton equal to about 907 kilograms.

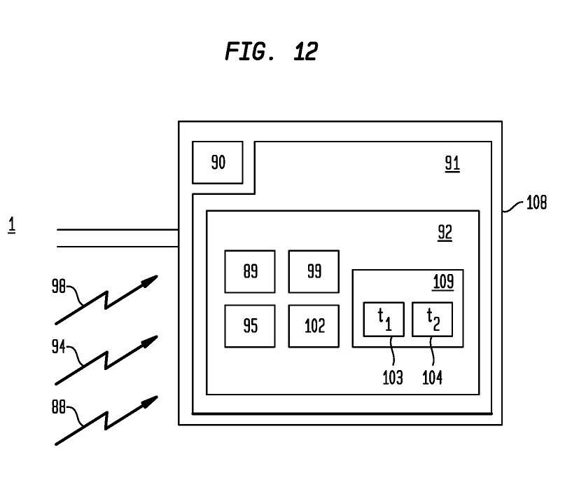

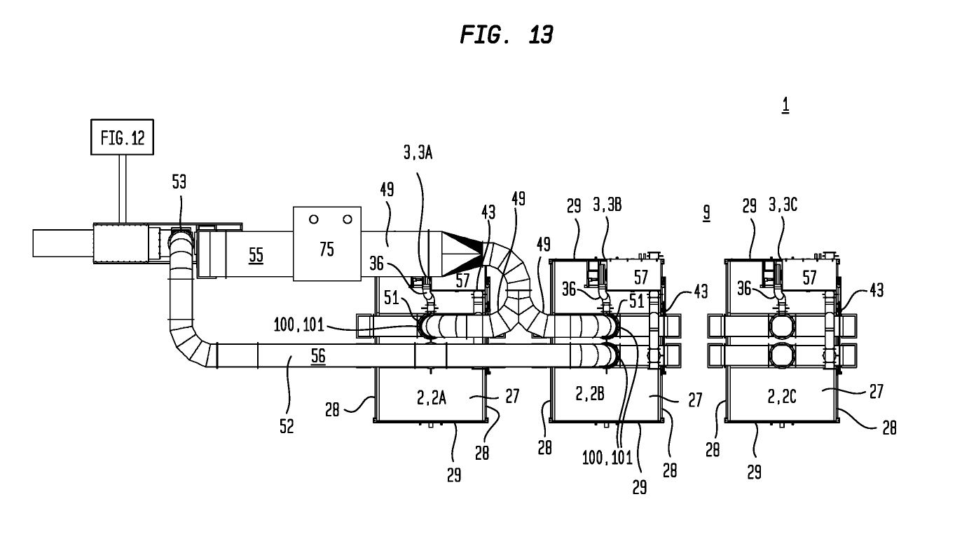

While the vessel (2) shown in the illustrative examples of FIGS. 1 through 7 includes a generally cylindrical vessel side wall (5) and generally circular vessel first and second end walls (6) (7), this is not intended to preclude embodiments in which the vessel (2) has a configuration with a substantially flat base (26), top (27), sides (28) and ends (29) joined to provide a square or rectangular box as shown in the illustrative example of FIGS. 12 and 13, such as a saliden box, cone, barrel, drum, or other like configuration.

The vessel (2) and the partition wall (10) can be of any substantially fluid impermeable rigid material capable of being exposed to a wide range of temperatures during one or a plurality of cycles of heating and cooling without melting, deforming, or otherwise failing during normal operation of the malting system. As illustrative examples, the vessel (2) and partition wall (10) can comprise: a plastic, a metal, a wood, a ceramic, glass, or combinations thereof.

Now referring generally to FIGS. 1 through 3, 5, 8 and 9, the first fluid flow generator (3) fluidicly coupled to the vessel (2) can, as an illustrative example, comprise a centrifugal fan (30) including a fan housing (31) surrounding an impeller (32) having a plurality of blades (33) (curved forward, backward or radial) rotatable at variable rounds per minute to increase or decrease the pressure and volume of a first fluid flow (34), and a fan drive mechanism (35), which can, but need not necessarily, be an electric motor which can directly or indirectly (i.e. belt and pulley or magnetic or centrifugal clutch) rotate the impeller (32). As one illustrative example, the first fluid flow generator (3) can be a pressure blower available from Cincinnati Fan. However, this illustrative example is not intended to limit the first fluid flow generator (3) to a centrifugal fan (30) and any device that can that can create a first fluid flow (34) at the necessary standard cubic feet per minute (“scfm”) per ton of the amount of material (“scfm/ton”) can be utilized. For the purposes of this invention the term “fluid flow” means any gas (or partial pressures of gases) that can flow between the first fluid flow generator (3) and the vessel (2) and which first fluid flow (34) may carry vapor or droplets of liquid, such as water.

In particular embodiments, the first fluid flow generator (3) can generate the first fluid flow (34) in a range between about 300 standard cubic feet per minute per ton of grain (scfm/ton) to about 600 scfm/ton. The first fluid flow (34) can be selected from the group consisting of: about 305 scfm/ton to about 320 scfm/ton, about 310 scfm/ton to about 330 scfm/ton, about 320 scfm/ton to about 340 scfm/ton, about 330 scfm/ton to about 350 scfm/ton, about 340 scfm/ton to about 360 scfm/ton, about 350 scfm/ton to about 370 scfm/ton, about 360 scfm/ton to about 380 scfm/ton, about 370 scfm/ton to about 390 scfm/ton, about 380 scfm/ton to about 400 scfm/ton, about 390 scfm/ton to about 410 scfm/ton, about 400 scfm/ton to about 420 scfm/ton, about 410 scfm/ton to about 430 scfm/ton, about 420 scfm/ton to about 440 scfm/ton, about 430 scfm/ton to about 450 scfm/ton, about 440 scfm/ton to about 460 scfm/ton, about 450 scfm/ton to about 470 scfm/ton, about 460 scfm/ton to about 480 scfm/ton, about 470 scfm/ton to 490 scfm/ton, about 480 scfm/ton to about 500 scfm/ton, about 490 scfm/ton to about 510 scfm/ton, about 500 scfm/ton to about 520 scfm/ton, about 510 scfm/ton to about 530 scfm/ton, about 520 scfm/ton to about 540 scfm/ton, about 530 scfm/ton to about 550 scfm/ton, about 540 scfm/ton to about 560 scfm/ton, about 550 scfm/ton to about 570 scfm/ton, about 560 scfm/ton to about 580 scfm/ton, about 570 scfm/ton to about 590 scfm/ton, about 580 scfm/ton to about 595 scfm/ton, and combinations thereof.

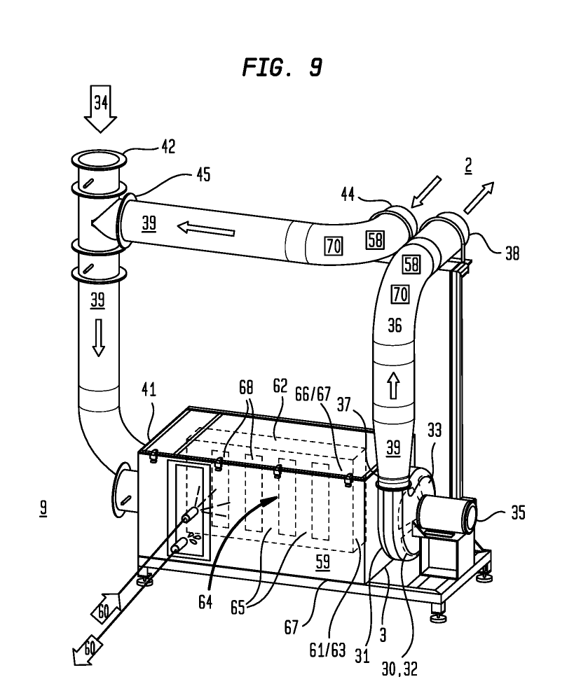

Again referring primarily to FIGS. 8 and 9, the first fluid flow generator (3) can be discretely fluidicly coupled to the vessel (2) by a first fluid conducting element (36). The first fluid conducting element (36) can have a tubular length disposed between a first end (37) and a second end (38), defining a first fluid flow path (39) between the first fluid flow generator (3) and the vessel (2). The first end (37) of the first fluid conducting element (36) can be removably coupled to the first fluid flow generator (3) and the second end (38) can be removably coupled to the vessel (2).

Again referring primarily to FIGS. 8 and 9, a second fluid conducting element (40) having a tubular length disposed between a first end (41) and a second end (42). The first end (41) of the second fluid conducting element (40) can be removably coupled to the first fluid flow generator (3) and the second end (42) of the second fluid conducting element (40) can be open to the ambient environment (9). As to particular embodiments, a third fluid conducting element (43) having a tubular length between a first end (44) and a second end (45) can be coupled between the vessel (2) and the second fluid conducting element(40).

As shown in FIGS. 8 and 9, the first fluid flow generator (3) can generate a first fluid flow (34) having a first fluid flow path (39) between the second end (42) of the second fluid conducting member (40) and the second end (38) of the first fluid flow conducting element (36). The first fluid flow (34) delivered to the vessel (2) circulates within the vessel (2) to contact the amount of material (24) disposed in the interior space (8) of the vessel (2). The first fluid flow (34) can, but need not necessarily, egress from the vessel (2) in a first fluid flow path (39) between the first end (44) and the second end (45) of the third fluid conducting element (43). The first fluid flow (34) can, but need not necessarily, return to the first fluid flow generator (3), or can, in whole or in part, flow to the ambient environment (9).

The first, second, and third fluid conducting element (36) (40) (43) can, as illustrative examples, comprise a plastic, a wood, a metal, or other like material, or combinations thereof, whether rigid or flexible, which can be substantially fluid impermeable and capable of being exposed to high temperatures, as described further herein, without melting, deforming, or otherwise failing upon application of the high temperatures for either one cycle or multiple cycles of heating and cooling of the malting system (1).

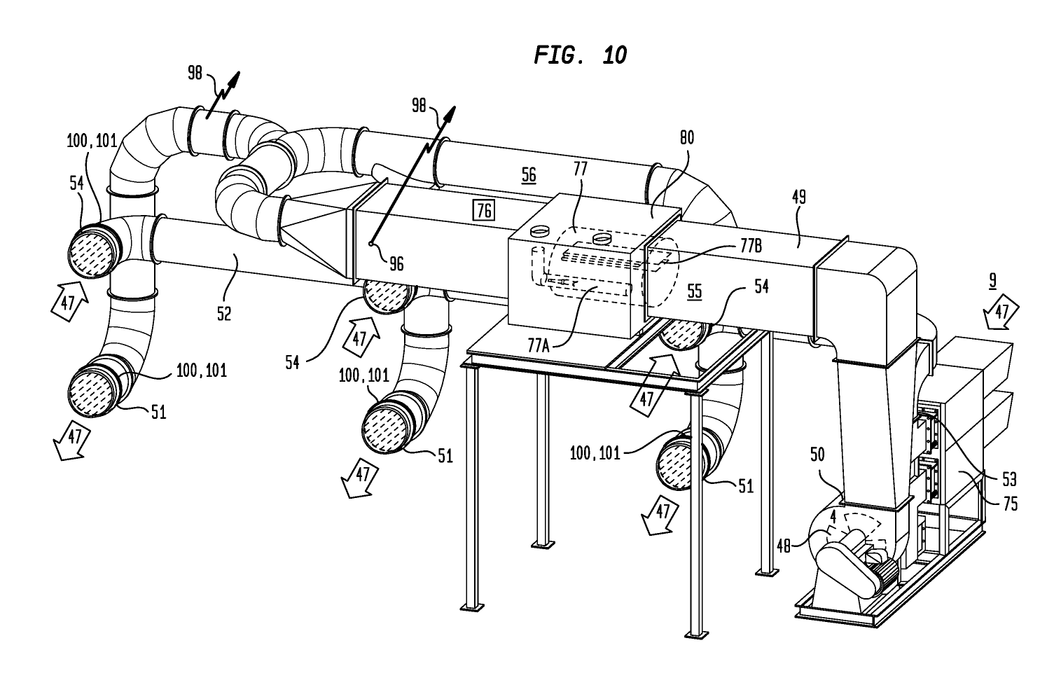

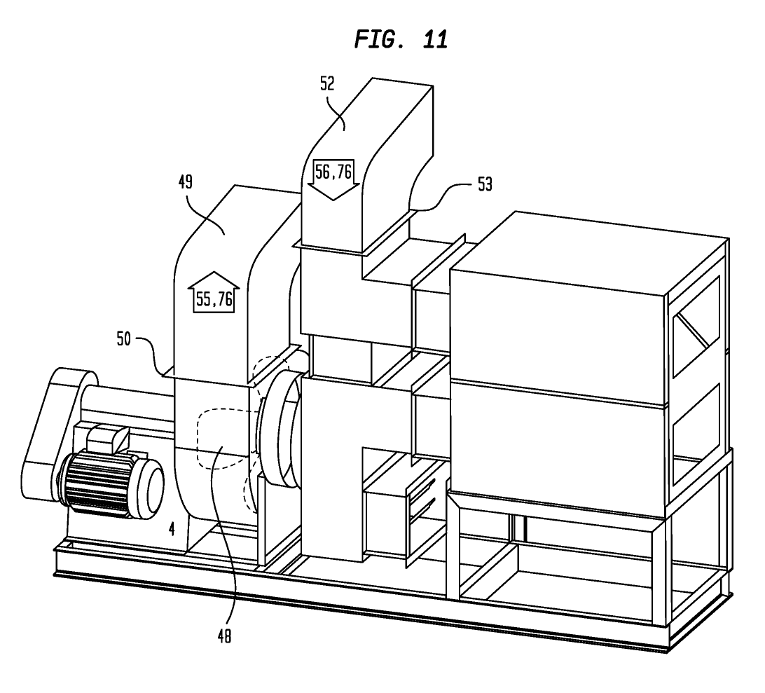

Now referring primarily to FIGS. 10 and 11, embodiments of the malting system (1) can, but need not necessarily, include a second fluid flow generator (4) which can be discretely fluidicly coupled to the vessel (2) and deliver a discrete second fluid flow (47) to the vessel (2). The second fluid flow generator (4) can, but need not necessarily, comprise a centrifugal fan (48), as above described. In particular embodiments, the second fluid flow generator (4) can generate a discrete second fluid flow (47) to the vessel (2) in a range between about 1800 scfm/ton of grain disposed in the vessel to about 3700 scfm/ton of grain disposed in the vessel (2). The second fluid flow (47) can have a scfm/ton selected from the group consisting of: about 1805 scfm/ton to about 1900 scfm/ton, about 1850 scfm/ton to about 1950 scfm/ton, about 1900 scfm/ton to about 2000 scfm/ton, about 1950 scfm/ton to about 2050 scfm/ton, about 2000 scfm/ton to about 2100 scfm/ton, about 2050 scfm/ton to about 2150 scfm/ton, about 2100 scfm/ton to about 2200 scfm/ton, about 2150 scfm/ton to about 2250 scfm/ton, about 2200 scfm/ton to about 2300 scfm/ton, about 2250 scfm/ton to about 2350 scfm/ton, about 2300 scfm/ton to about 2400 scfm/ton, about 2350 scfm/ton to about 2450 scfm/ton, about 2400 scfm/ton to about 2500 scfm/ton, about 2450 scfm/ton to about 2550 scfm/ton, about 2500 scfm/ton to about 2600 scfm/ton, about 2550 scfm/ton to about 2650 scfm/ton, about 2600 scfm/ton to about 2700 scfm/ton, about 2650 scfm/ton to about 2750 scfm/ton, about 2700 scfm/ton to about 2800 scfm/ton, about 2750 scfm/ton to about 2850 scfm/ton, about 2800 scfm/ton to about 2900 scfm/ton, about 2850 scfm/ton to about 2950 scfm/ton, about 2900 scfm/ton to about 3000 scfm/ton, about 2950 scfm/ton to about 3050 scfm/ton, about 3000 scfm/ton to about 3100 scfm/ton, about 3050 scfm/ton to about 3150 scfm/ton, about 3100 scfm/ton to about 3200 scfm/ton, about 3150 scfm/ton to about 3250 scfm/ton, about 3200 scfm/ton to about 3300 scfm/ton, about 3250 scfm/ton to about 3350 scfm/ton, about 3300 scfm/ton to about 3400 scfm/ton, about 3350 scfm/ton to about 3450 scfm/ton, about 3400 scfm/ton to about 3500 scfm/ton, about 3450 scfm/ton to about 3550 scfm/ton, about 3500 scfm/ton to about 3600 scfm/ton, about 3550 scfm/ton to about 3650 scfm/ton, about 3600 scfm/ton to about 3695 scfm/ton, and combinations thereof.

The second fluid flow (47) can be conducted by a fourth fluid conducting element (49) having a tubular length disposed between first and second ends (50) (51). The fourth fluid conducting element (49) can be removably coupled by the first end (50) to the second fluid flow generator (4) and the second end (51) of the fourth fluid conducting element (49) can be removably coupled to the vessel (2). Particular embodiments can further include a fifth fluid conducting element (52) having a tubular length disposed between first and second ends (53) (54). The second end (54) of the fifth fluid conducting element (52) can be removably coupled to the vessel (2), and the first end (53) of the fifth conducting element (52) can be removably coupled to the second fluid flow generator (4) or, in whole or in part, remain open to the ambient environment (9). The fourth and fifth fluid conducting elements (49) (52) can, as illustrative examples, comprise: a plastic, a metal, a wood, or other like rigid or flexible material, which can be substantially fluid impermeable and capable of being exposed to high temperatures, as described further herein, without melting, deforming, or otherwise failing in either one cycle or multiple cycles of heating and cooling of the malting system (1). The second fluid flow generator (4) can generate a discrete second fluid flow (47) to the vessel (2), where the second fluid flow (47) can have a direction of flow conducted from the second fluid flow generator (4) to the vessel (2) utilizing the flow path (55) defined by the fourth fluid conducting element (49). The second fluid flow (47) circulates in the vessel (2) in contact with the amount of grain (25) disposed in the vessel (2), and utilizing the flow path (56) defined by the fifth fluid conducting element (52) egresses from the vessel (2) to return to the second fluid flow generator (4).

Now referring primarily to FIG. 9, particular embodiments of the malting system (1) can include a first temperature regulation element (57), operable to discretely regulate the first fluid flow temperature (58) of the first fluid flow (34) generated by the first fluid flow generator (3). The first fluid flow temperature (58) of the first fluid flow (34) in the vessel (2) can be selected from a range between about 0° C. to about 27° C. As to particular embodiments, the first fluid flow temperature (58) of the first fluid flow (34) in the vessel can be selected from the group including or consisting of: about 0.5° C. to about 5° C., about 2.5° C. to 7.5° C., about 5° C. to about 10° C., about 7.5° C. to about 12.5° C., about 10° C. to about 15° C., about 12.5° C. to about 17.5° C., about 15° C. to about 20° C., about 17.5° C. to about 22.5° C., about 20° C. to about 25° C., and about 22.5° C. to about 26° C., and combinations thereof.

The first temperature regulation element (57) can be disposed in the first fluid flow path (39) to engage the first fluid flow (34) conducted to the vessel (2). As shown in the examples of Figures ______, the first temperature regulation element (57) can be disposed in the first fluid flow path (39) between the second fluid conducting element (40) and the first fluid flow generator (3) to allow the first fluid flow to be drawn through the first temperature regulation element (57) to the first fluid flow generator; however, this example does not preclude embodiments in which the first temperature regulation element (57) has a location otherwise in the first fluid flow path (34) effective to generate a first fluid flow temperature (58) in one or more of the above described ranges. As shown in the example of FIG. 9, a radiator heat exchanger (59) receives a flow of heated fluid (60) (whether steam or liquid). The heated fluid (60) can be fed into a first tank (61) of the radiator (located either on the top (62) of the radiator, or along one side (63)), from which it is distributed across the radiator core (64) through tubes (65) to a second tank (66) on the opposite end (67) of the radiator heat exchanger (59). As the heated fluid (60) passes through the radiator tubes (65) to the second tank (66), it transfers heat to the tubes (65) which, in turn, transfer the heat to the fins (68) that disposed between each row of tubes (65). The fins (68) then release the heat to the first fluid flow (34) to increase the first fluid flow temperature (58). However, this illustrative example is not intended to preclude the use of a wide variety of first temperature regulation elements (57) including, as illustrative examples, one or more of: a radiator, a water to air heat exchanger, a shell and tube heat exchanger, plate heat exchanger, regenerative heat exchanger, adiabatic wheel exchanger, or other heat exchanger.

Again referring primarily to FIG. 10, as to particular embodiments, the malting system (1), can, but need not necessarily, further include a humidifying element (69) disposed in the first fluid flow (34). The humidifying element (69) can operate to discretely regulate the relative humidity (70) of the first fluid flow (34) generated by the first fluid flow generator (3) and conducted to the vessel (2). For the purposes of this invention, the term “relative humidity” means the ratio of the water vapor density (mass per unit volume) to the saturation water vapor density (mass per unit volume), expressed as a percentage. The humidifying element (69) can discretely regulate the relative humidity (70) of the first fluid flow (34) in a range of about 35 percent (“%”) to about 100%. The relative humidity (70) of the first fluid flow (34) can be selected from the group including or consisting of: about 36% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, and about 90% to about 99%, and combinations thereof. The humidifying element (69) can, as shown in the illustrative example of FIG. 8, comprise a plurality of nozzles (71), disposed in the first fluid flow (34) in the first fluid conducting element (36), dispersing an amount of water (72) as a plurality of droplets (73) or as a mist (74) into the first fluid flow (34). As to the particular embodiment shown, the plurality of nozzles (71) can be positionally located in line with the first temperature regulation element (57) prior to being drawn into the first fluid flow generator (3). A suitable nozzle (71) for use in embodiments can be a high-pressure ruby-orifice nozzle available from Atomizing Systems Inc., Part No. ASI-6R. The illustrative embodiment of the humidifying element (69) shown in FIG. 8 is not intended to preclude the use of a numerous and wide variety of humidifying elements (69) which may be located at other locations in the first fluid flow (34) which can generate the relative humidity (70) in the vessel (2) in the range of about 35% to about 100%; and as further illustrative examples the humidifying element (69) can comprise one or more of: a steam humidifier, direct or live stream injection humidifiers, ultrasonic humidifiers, or other like humidifying elements (69), which can which can generate the relative humidity (70) in the vessel (2) in the range of about 35% to about 100%.

Now referring primarily to FIG. 10, particular embodiments of the malting system (1) can include a second temperature regulation element (75) operable to discretely regulate the second fluid flow temperature (76) of the second fluid flow (47) generated by the second fluid flow generator (4). The second fluid flow temperature (76) of the second fluid flow (47) can range between about 50° C. to about to about 205° C. The second fluid flow temperature (76) of the second fluid flow (47) can be selected from the group including or consisting of: about 55 degrees centigrade (“° C.”) to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 95° C. to about 105° C., about 100° C. to about 110° C., about 105° C. to about 115° C., about 110° C. to about 120° C., about 115° C. to about 125° C., about 120° C. to about 130° C., about 125° C. to about 135° C., about 130° C. to about 140° C., about 135° C. to about 145° C., about 140° C. to about 150° C., about 145° C. to about 155° C., about 150° C. to about 160° C., about 155° C. to about 165° C., about 160° C. to about 170° C., about 165° C. to about 175° C., about 170° C. to about 180° C., about 175° C. to about 185° C., about 180° C. to about 190° C., about 185° C. to about 195° C., about 190° C. to about 200° C., and about 195° C. to about 204° C., and combinations thereof.

As shown in the example of FIG. 10, the second temperature regulation element (75) can be an indirect gas fire heater (77) having a burn chamber (77A), wherein the heat produced by the combustion of gas in the burn chamber is conducted to a heat exchanger (77B), which subsequently conducts heat to the second fluid flow (47). However, this illustrative example is not intended to preclude the use of a wide variety of second temperature regulation elements (75) which can regulate the second fluid flow temperature (76) in the range of about 50° C. to about to about 205° C. with a second fluid flow (47) in the range of about 1800 scfm/ton to about 3700 scfm/ton including, as illustrative examples, one or more of: a radiator, a water to air heat exchanger, a shell and tube heat exchanger, plate heat exchanger, regenerative heat exchanger, adiabatic wheel exchanger, or other heat exchanger.

Now referring primarily to FIGS. 1, 8, and 12, particular embodiments of the malting system (1) can include a first temperature sensor (87), which can sense the first fluid flow temperature (58) of the first fluid flow (34). The first temperature sensor (87) can generate a first temperature sensor signal (88) which varies based on the first fluid flow temperature (58) of the first fluid flow (34). The first temperature sensor signal (88) can, but need not necessarily, be received by a first temperature controller (89) having a processor (90) communicatively coupled to a memory element (91) including a program (92) executable to analyze the first temperature sensor signal (88) and compare the first fluid flow temperature (58) to a pre-selected first fluid flow temperature (58), and correspondingly control operation of the first temperature regulation element (57) to increase, decrease or maintain the amount of heat generated by the first temperature regulation element (57) to maintain the first fluid flow temperature (58) at a pre-selected first fluid flow temperature (58) for the first fluid flow (34). The first temperature controller can be included as a component of a system controller (108). The first temperature sensor (87) can be responsive to the first fluid flow (34) or disposed on or in in the first fluid conducting element (36), the second fluid conducting element (40), the third fluid conducting element (43) or in the interior space (8) of the vessel (2). Further, particular embodiments can include a plurality of first temperature sensors (87) responsive to the first fluid flow (34), disposed on or in the first, second or third fluid conducting element (36) (40) (43), or disposed on or in the interior space (8) of the vessel (2), or any combination thereof, where each of the plurality of first temperature sensor signals (88) can, but need not necessarily, be received by the first temperature controller (89), which can control operation of the first temperature regulation element (57) to increase, decrease, or maintain the first fluid flow temperature (58) of the first fluid flow (34) in the first fluid flow path (39) or in the vessel (2). As illustrative examples, the first temperature sensor (87) can be one or more of: a negative temperature coefficient thermistor, a resistance temperature detector, thermocouple, semiconductor-based sensor, or other like temperature sensor.

Now referring primarily to FIG. 7, particular embodiments of the malting system (1) can include a humidity sensor (96) which can sense the relative humidity (70) of the first fluid flow (34). The humidity sensor (96) can generate a humidity sensor signal (94) which varies based on the relative humidity (70) of the first fluid flow (34). The humidity sensor signal (94) can, but need not necessarily, be received by a humidity controller (95) which controls the operation of the humidifying element (69) disposed in the first fluid flow (34). The humidity controller (95) can be discrete from the a first temperature controller (89) or can utilize the processor (90) communicatively coupled to a memory element (91), including the program (92), of the system controller (108), which can be further executable to analyze the first humidity sensor signal (94) and compare the relative humidity (70) of the first fluid flow (34) to a pre-selected relative humidity (70) of the first fluid flow (34), and correspondingly control operation of the humidifying element (69) to increase, decrease or maintain the relative humidity (70) generated by the humidifying element (69) to maintain the relative humidity (70) of the first fluid flow (34) at a pre-selected relative humidity (70) of the first fluid flow (34).

The humidity sensor (93) can be responsive to the first fluid flow (34) and disposed on or in the first, second, or third fluid conducting element (36) (40) (43), or disposed on or in the interior space (8) of the vessel (2). As to particular embodiments, a plurality of humidity sensors (93) responsive to the relative humidity (70) of the first fluid flow at different locations on or in the first, second, or third fluid conducting element (36) (40) (43) or the interior space (8) of the vessel (2), or any combination thereof, where each of the plurality of humidity sensors (93) can, but need not necessarily, be received by the humidity controller (95) As illustrative examples, the humidity sensor (93) can be a capacitative humidity sensor, resistive humidity sensor, or other like sensor, or combinations thereof.

Now referring primarily to FIG. 10, particular embodiments of the malting system (1) can include a second temperature sensor (96), which can sense the second fluid flow temperature (97) of the second fluid flow (47). The second temperature sensor (96) can generate a second temperature sensor signal (98) which varies based on the second fluid flow temperature (97) of the second fluid flow (47). The second temperature sensor (96) can, but need not necessarily, be received by a second temperature controller (99) which controls the operation of the second temperature regulation element (75). The second temperature controller (99) can be discrete from the first temperature controller (89) or can utilize the processor (90) communicatively coupled to a memory element (91), including the program (92), of the system controller (108) which can be further executable to analyze the second temperature sensor signal (98) and compare the second fluid flow temperature (97) of the second fluid flow (47) to a pre-selected second fluid flow temperature (97) of the second fluid flow (47), and correspondingly control operation of the second temperature regulation element (75) to increase, decrease or maintain the second fluid flow temperature (76) generated by the second temperature regulation element (75) to maintain the second fluid flow temperature (76) of the second fluid flow (47) at a pre-selected second fluid flow temperature (76).

The second temperature sensor (96) can be responsive to the second fluid flow (47) and can be disposed on or in fourth or fifth fluid conducting element (49) (52), or disposed on or in the interior space (8) of the vessel (2). Further, particular embodiments can include a plurality of second temperature sensors (96) disposed on or in the fourth or fifth fluid conducting elements (49) (52) or disposed in or on the interior space (8) of the vessel (2), or combinations thereof, where each of the plurality of second temperature sensor signals (98) can, but need not necessarily, be received by the second temperature controller (99). As illustrative examples, the second temperature sensor (96) can be a negative temperature coefficient thermistor, a resistance temperature detector, thermocouple, semiconductor-based sensor, or other like temperature sensor, or combinations thereof.

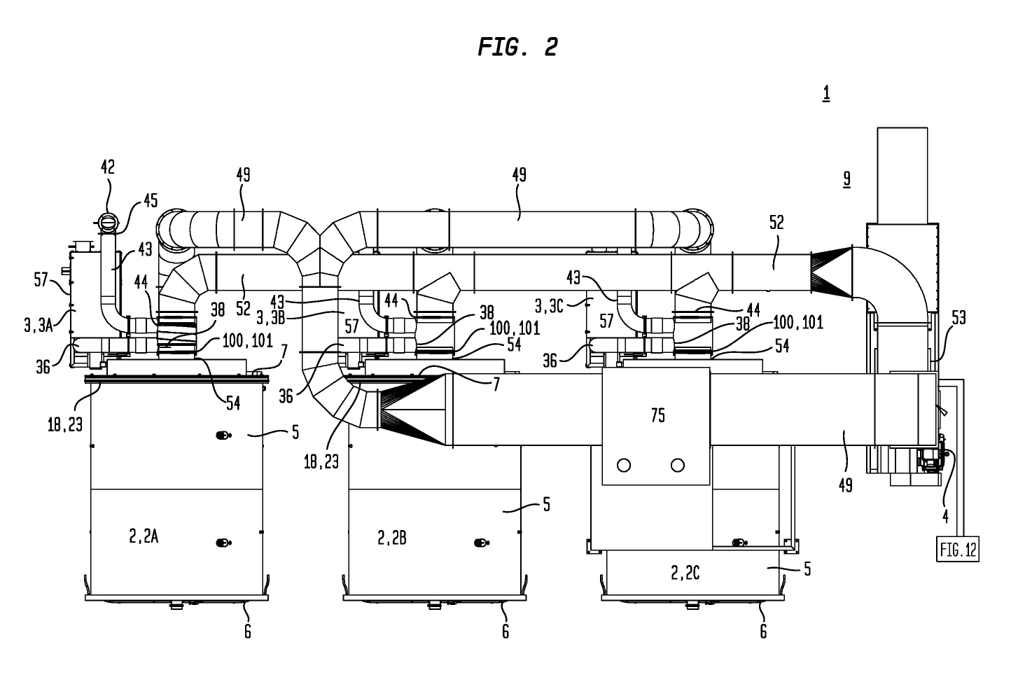

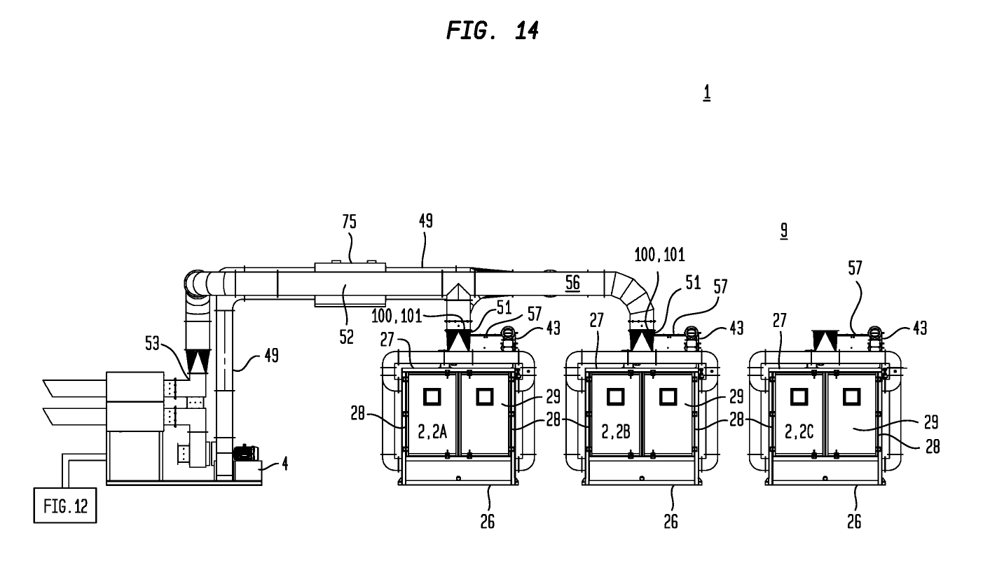

Now referring primarily to FIGS. 2, 5, 10, and 13 through 14, particular embodiments of the malting system (1) can include a baffle (100) continuously or intermittently responsive to the second fluid flow (47) to direct the second fluid flow (47) generated by the second fluid flow generator (4), in whole or in part, toward or away from the vessel (2). The baffle (100) can be disposed in or on the fourth fluid conducting element (49). The baffle (100) can be a flow directing vane or panel which can be manually or automatically positioned by operation of a motorized baffle (101) responsive to a baffle controller (102), in order to a greater or lesser extent restrict the second fluid flow (47) to the vessel (2). The baffle controller (102) can be discrete from the first and second temperature controller (89) (99) or the humidity controller (95) or can utilize the processor (90) communicatively coupled to a memory element (91), including the program (92), of the system controller (108), which can be further executable to position the baffle (100) in the fourth fluid conducting element (49) to direct the second fluid flow (47) toward or away from or to a greater or lesser extent restrict the second fluid flow (47) to the vessel (2) based on occurrence of a pre-selected time or condition of the amount of grain (25) in the vessel (2). The baffle (100) can be comprised of metal, plastic, wood, or other like rigid material, which can be substantially fluid impermeable and capable of being exposed to high temperatures, as described further herein, without melting, deforming, or otherwise failing upon application of the high temperatures for either one cycle or multiple cycles of heating and cooling in the malting system (1).

Now referring primarily to FIGS. 1 through 5 and 13 through 14, particular embodiments of the malting system (1) can include a plurality of vessels (2), a plurality of first fluid flow generators (3), and, depending on the embodiment, one or more of a plurality of first, second and third fluid conducting elements (36) (40) (43), as those components are above described. One of the first fluid flow generators (3) can be discretely coupled to a corresponding one of the plurality of vessels (2), where each one of the plurality of first fluid flow generators (3) can be capable of discretely generating a first fluid flow (34) to a corresponding one of the plurality of vessels (2). As to particular embodiments, each one of the plurality first fluid flow generators (3) can be discretely removably coupled to a corresponding one of the plurality of vessels (2) with a corresponding one of the plurality of first fluid conducting elements (36), as above described. Particular embodiments can, but need not necessarily, further include a plurality of second fluid conducting elements (40), where each of the plurality of second fluid conducting elements (40) can be removably coupled to the corresponding one of the plurality of vessels (2), as above described.

Again referring primarily to FIGS. 1 through 5 and 13 through 14, particular embodiments of the malting system can, but need not necessarily, include a plurality of first temperature regulation elements (57), as the first temperature regulation element (57), as described above. One of the plurality of first temperature regulation elements (57) can be operable to discretely regulate the first fluid flow temperature (58) of the first fluid flow (34) generated by each of the plurality of first fluid flow generators (3) coupled to a corresponding one of said plurality of vessels (2).

Now referring primarily to FIGS. 1 through 5 and 13 through 14, particular embodiments of the malting system (1) can, but need not necessarily, include a plurality of humidifying elements (69), as above described. Each one of the plurality of humidifying elements (69) can be operable to discretely regulate the relative humidity (70) of the first fluid flow (34) generated by each of the corresponding plurality of first fluid flow generators (3) discretely coupled to a corresponding one of the plurality of vessels (2).

Now referring primarily to FIGS. 1 through 5 and 13 through 14, particular embodiments of the malting system (1) can include a plurality of first temperature sensors (87), as above described. Each one of the plurality of first temperature sensors (87) can be operable to generate a first temperature sensor signal (88) which varies based on the first fluid flow temperature (58) of the first fluid flow (34) of a corresponding one of the plurality of first fluid flow generators (3) discretely coupled to a corresponding one of said plurality of vessels (2). Particular embodiments can, but need not necessarily, include a first temperature controller (89), as above described, or plurality of first temperature controllers (89), which receive the plurality of first temperature sensor signals (88), where the first temperature controller (89), or each one of the plurality of first temperature controllers (89), can analyze each of the first temperature sensor signals (88) and compare each the plurality of first fluid flow temperatures (58) of each of the plurality of first fluid flows (34) to a corresponding plurality of pre-selected first fluid flow temperatures (58), and correspondingly control operation of each of the plurality of first temperature regulation elements (57) to increase, decrease or maintain the amount of heat generated by each of the plurality of first temperature regulation elements (57) to maintain each of the plurality of first fluid flow temperatures (58) of each of the plurality of first fluid flows (34) at the corresponding one of the plurality of pre-selected first fluid flow temperatures (58).

FIGS. 1 through 5 and 13 through 14, particular embodiments of the malting system (1) can include a plurality of humidity sensors (93), as above described. Each one of the plurality of humidity sensors (93) can be operable to generate a humidity sensor signal (94) which varies based on the relative humidity (70) of the first fluid flow (34) of a corresponding one of the plurality of first fluid flow generators (3) discretely coupled to a corresponding one of the plurality of vessels (2). Particular embodiments can, but need not necessarily, include a humidity controller (95), as above described, or plurality of humidity controllers (95), which receive the plurality of humidity sensor signals (94), where the humidity controller (95), or each one of the plurality of humidity controllers (95), can analyze each of the plurality of humidity sensor signals (94) and compare the relative humidity (70) of each the plurality of first fluid flows (34) to a corresponding plurality of pre-selected relative humidities (70), and correspondingly control operation of each of the plurality of humidifying elements (69) to increase, decrease or maintain the relative humidity (70) of each of the plurality of first fluid flows (34) at the corresponding one of the plurality of pre-selected relative humidities (70).

FIGS. 1 through 5 and 13 through 14, particular embodiments of the malting system (1) can include a plurality of baffles (100), as above described. Each of the plurality of baffles (100) can be operable to discretely divert the second fluid flow (47) generated by the second fluid flow generator (4) in whole or in a part toward or away from each of the plurality of vessels (2). The plurality of baffles (100) can each be disposed within the fourth fluid conducting element (49).

Now referring to FIGS. 1 through 3, 6, and 12 through 14, a particular method of using a malting system (1) can, but need not necessarily include, disposing an amount of grain (25) in a vessel (2), discretely fluidicly coupling a first fluid flow (34) generated by a first fluid flow generator (3) to the vessel (2) for a first duration of time (103), and discretely fluidicly coupling a second fluid flow (47) generated by the second fluid flow generator (4) to the vessel (2) for a second duration of time (104). The timer (109) used to determine the first duration of time and the second duration of time can utilize the processor (90) communicatively coupled to a memory element (91), including the program (92), of the system controller (108), thereby communicatively coupling the timer (109) to the humidifying controller (95), first temperature controller (89), second temperature controller (99), and baffle controller (102) in particular embodiments. The first fluid flow (34) can have a first fluid flow temperature (58) and a relative humidity (70) selected to germinate the amount of grain (25) in the vessel (2). The second fluid flow (47) can have a second fluid flow temperature (97) selected to dry the amount of grain (25) in the vessel (2). For the purposes of this invention the term “dry” means the removal of moisture from the amount of grain (25) to the extent that the amount of grain (25) contains moisture between about 5% to about 15% by weight. The amount of moisture by weight can be selected from the group including or consisting of: about 5.5% to about 10%, about 7.5% to about 12.5%, about 10% to about 14.5%, and combinations thereof.

Particular embodiments of the method of using a malting system (1) can, but need not necessarily, further include operating a first temperature regulation element (57) to regulate the first fluid flow temperature (58) of the first fluid flow (34) generated by the first fluid flow generator (3). The first fluid flow temperature (58) of the first fluid flow (34) can be pre-selected by the user from the range of first fluid flow temperature (58) above described.

Additionally, particular embodiments of the method of using malting system (1) can, but need not necessarily, further include operating a humidifying element (69) to regulate the relative humidity (70) of the first fluid flow (34) generated by the first fluid flow generator (3)). The relative humidity (70) of the first fluid flow (34) can be pre-selected by the user from the ranges above described.

Further, particular embodiments of the method of using malting system (1) can, but need not necessarily, include operating a second temperature regulation element (75) to regulate the second fluid flow temperature (76) of the second fluid flow (47) generated by the second fluid flow generator (4). The second fluid flow temperature (76) of the second fluid flow (47) can be pre-selected by the user from the ranges above described.

Now referring to FIGS. 1 through 3, 6, and 12 through 14, particular embodiments of the method of using a malting system (1) can, but need not necessarily, include pre-selecting or adjusting the first fluid flow temperature (58) of the first fluid flow (34) by entering indications of the pre-selected first fluid flow temperature (58) into the first temperature controller (89), whether by manual adjustment, click event or touch on in a display surface of a computer, or other user interaction with an interface of the first temperature controller. The first temperature controller (89) subsequently regulates the first fluid flow temperature (58) of the first fluid flow (34) based on sensed first fluid flow temperature(s) (58) of the first fluid flow (34) in the first, second, or third fluid conducting element (36) (40) (43) or in the vessel (2) in comparison to the entered indications of the pre-selected first fluid flow temperature (58).

Particular embodiments of the method of using a malting system (1) can, but need not necessarily, include preselecting or adjusting the relative humidity (70) of the first fluid flow (34) by entering indications of the pre-selected relative humidity (70) into the humidity controller (95), whether by manual adjustment, click event or touch on in a display surface of a computer, or other user interaction with an interface of the first temperature controller (89). The humidity controller (95) can subsequently regulate the relative humidity (70) of the first fluid flow (34) based on the sensed relative humidity (70) of the first fluid flow (34) in the first, second, or third fluid conducting element (36) (40) (43) or in the vessel (2) in comparison to the entered indications of the pre-selected relative humidity (70).

Particular embodiments of the method of using a malting system (1) can, but need not necessarily, include preselecting or adjusting the second fluid flow temperature (76) of the second fluid flow (47) by entering indications of the pre-selected second fluid flow temperature (76) into the second temperature controller (99), whether by manual adjustment, click event or touch on in a display surface of a computer, or other user interaction with an interface of the first temperature controller (89). The second temperature controller (99) subsequently regulates the second fluid flow temperature (76) of the second fluid flow (47) based on sensed second fluid flow temperature(s) (76) of the second fluid flow (47) in the fourth or fifth fluid conducting element (49) (52) or in the vessel (2) in comparison to the entered indications of the pre-selected second fluid flow temperature (76).

Now referring primarily to FIGS. 1 through 3, 6, and 12 through 14, particular embodiments of the method of using the malting system (1) can include operating a baffle (100) to divert the second fluid flow (47), whether in whole or in part, toward or away from the vessel (2). As to particular embodiments of the method, the operation of the baffle (100) can be preselected based on timing or occurrence of an event, such as a particular percent moisture by entering indications of the pre-selected time or event occurrence into the baffle controller (102), whether by manual adjustment, click event or touch on in a display surface of a computer, or other user interaction with an interface of the baffle controller. The baffle controller (102) subsequently regulates the operation of the baffle (100) based on sensed elapse of time or event occurrence in comparison to the entered indications of the pre-selected amount of time or event occurrence.

Now referring primarily to FIGS. 1 through 3, 6, and 12 through 14, particular embodiments of the method of using a malting system can include disposing an amount of grain (25) in a plurality of vessels (2), discretely fluidicly coupling one of a plurality of first fluid flows (34) generated by a corresponding plurality of first fluid flow generators (3) to each of the plurality of vessels (2), wherein one of the plurality of first fluid flow generators (3) discretely fluidicly coupled to a corresponding one of the plurality of vessels (2) generates a first fluid flow (34) for a first duration of time to germinate an amount of grain (25). The first duration of time (103) in which each one of plurality of first fluid flow generators (3) operates to generate a corresponding first fluid flow (34) to a corresponding one of the plurality of vessels (2) can be in overlapping, abutting or discontinuous time periods. This structure of the malting system (1) allows only one, more than one, or all of the plurality of first fluid flow generators (3) to be operational in a first duration of time (103). Similarly, by operation of one or more of the plurality of baffles (100) the second air flow (47) discretely generated by the second fluid flow generator (4) can be directed to only one, more than one, or all of the plurality of vessels (2) for a second duration of time (104) to dry an amount of grain (25). The timer (109) used to determine the first duration of time and the second duration of time can utilize the processor (90) communicatively coupled to a memory element (91), including the program (92), of the system controller (108), thereby communicatively coupling the timer (109) to the humidifying controller (95), first temperature controller (89), second temperature controller (99), and baffle controller (102) in particular embodiments.

As one illustrative example, if the plurality of vessels (2A, 2B, 2C) equals three, then as to the first of the plurality of vessels (2A), an amount of grain (25) can be placed within the interior space (8), as to the second of the plurality of the vessels (2), only the corresponding first fluid flow generator (3) can be operating to generate the first fluid flow (34) in the vessel (2B) to allow germination of an amount of grain (25) prior placed in the interior space (8) within the vessel (2B), and as to the third of the plurality of vessels (2C), the second fluid flow generator (4) can be operating with the corresponding one of the plurality of baffles (100) in the open condition (106) to direct the second fluid flow (47) to the third of the plurality of vessels (2) to dry the amount of grain (25) previously germinated, while the remaining plurality of baffles (100) remain in the closed condition (107) to interrupt the second fluid flow (47) to the first and second of the plurality of vessels (2A, 2B), thereby allowing continuous staggered stepwise treatment of the amount of grain (25) in each vessel (2) through the steps of loading the amount of grain (25) into a vessel (2), germinating the amount of grain in the vessel (2), drying the amount of grain (25) in the vessel (2), and unloading the dried amount of grain (25) from the vessel (2).

As to particular embodiments of the method of using a malting system (1), the method can, but need not necessarily, include discretely operating a plurality of first temperature regulation elements (57) to individually regulate the first fluid flow temperature (58) of each of the first fluid flows (34) generated by the plurality of first fluid flow generators (3). The method can, but need not necessarily, include selecting each the plurality of first fluid flow temperatures (58) of the first fluid flows (34) from the ranges ab above described.

Additionally, particular embodiments of the method of using a malting system (1) can, but need not necessarily, include operating a plurality of humidifying elements (69) to individually regulate the plurality of relative humidities (70) of the first fluid flows (34) generated by each corresponding one of the plurality of first fluid flow generators (3). The method can, but need not necessarily, include selecting each of the plurality of relative humidities (70) of the first fluid flow (34) from the ranges above described. Further particular embodiments of the method can, but need not necessarily, include regulating the second fluid flow temperature (76) of the second fluid flow (47) generated by the second fluid flow generator (4) from the ranges described previously.

Particular embodiments of the method of using a malting system (1) can, but need not necessarily, include generating a first fluid flow having a scfm/ton of the first fluid flow (34) in the range above described. Further particular embodiments of the method can, but need not necessarily, include generating a second fluid flow having a scfm/ton of the second fluid flow (47) in the range above described.

Now referring to FIG. 12, particular embodiments of the method of using a malting system (1) can, but need not, include adjusting or entering indications of each of a plurality of pre-selected first fluid flow temperatures (58) into a first temperature controller (89) or plurality of first temperature controllers (89) to pre-select the first fluid flow temperatures (58) of each of the first fluid flows (34) generated by each one of the plurality of first fluid flow generators (3) to a corresponding one of the plurality of vessels (2).

Particular embodiments of the method of using a malting system (1) can, but need not necessarily, include adjusting or entering indications of each of a plurality of relative humidities (70) into a humidity controller (95), or a plurality of humidity controllers (95), to pre-select each of the plurality of relative humidities (70) of the first fluid flows (34) generated by each one of a plurality of first fluid flow generators (3) to a corresponding one of the plurality of vessels (2) in particular embodiments.

Particular embodiments of the method of using a malting system (1) can, but need not necessarily, include adjusting or entering indications of a second fluid flow temperature (76) into a second temperature controller (99) to pre-select the second fluid flow temperature (76) of the second fluid flow (47) received by each one of a plurality of vessels (2).

As can be easily understood from the foregoing, the basic concepts of the present invention may be embodied in a variety of ways. The invention involves numerous and varied embodiments of a malting system and methods for making and using such malting system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “first fluid flow generator” should be understood to encompass disclosure of the act of “generating a first fluid flow”—whether explicitly discussed or not—and, conversely, were there effectively disclosure of the act of “generating a first fluid flow”, such a disclosure should be understood to encompass disclosure of a “first fluid flow generator” and even a “means for generating a first fluid flow.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the malting systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification. if any. are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An apparatus, comprising:
a vessel;
a first fluid flow generator discretely fluidicly coupled to said vessel, said first fluid flow generator capable of generating a first fluid flow to said vessel; and
a second fluid flow generator discretely fluidicly coupled to said vessel, said second fluid flow generator capable of discretely generating a second fluid flow to said vessel.

2. The apparatus of claim 1, wherein said vessel comprises a plurality of vessels, and wherein said first fluid flow generator comprises a plurality of first fluid flow generators, one of said plurality of first fluid flow generators fluidicly coupled to a corresponding one of said plurality of vessels, each one of said plurality of first fluid flow generators capable of discretely generating said first fluid flow to a corresponding one of said plurality of vessels.

3. The apparatus of claim 2, further comprising a first temperature regulation element operable to regulate the temperature of said first fluid flow generated by said plurality of first fluid flow generators.

4. The apparatus of claim 3, wherein said first temperature regulation element comprises a plurality of first temperature regulation elements, one of said plurality of first temperature regulation elements operable to discretely regulate temperature of said first fluid flow generated by a corresponding one of said plurality of first fluid flow generators fluidicly coupled to a corresponding one of said plurality of vessels.

5. The apparatus of claim 4, further comprising a humidifying element operable to regulate the relative humidity of said first fluid flow generated by said plurality of first fluid flow generators.

6. The apparatus of claim 5, wherein said humidifying element comprises a plurality of humidifying elements, one of said plurality of humidifying elements operable to discretely regulate the relative humidity of said first fluid flow generated by a corresponding one of said plurality of first fluid flow generators fluidicly coupled to a corresponding one of said plurality of vessels.

7. The apparatus of claim 6, wherein said first temperature regulation element operable to discretely regulate the temperature of said first fluid flow within said vessel in a range between about 0° C. to about 27° C.

8. The apparatus of claim 7, wherein said temperature of said first fluid flow is selected from the group consisting of: about 0.5° C. to about 5° C., about 2.5° C. to 7.5° C., about 5° C. to about 10° C., about 7.5° C. to about 12.5° C., about 10° C. to about 15° C., about 12.5° C. to about 17.5° C., about 15° C. to about 20° C., about 17.5° C. to about 22.5° C., about 20° C. to about 25° C., and about 22.5° C. to about 26° C., and combinations thereof.

9. The apparatus of claim 7, wherein said humidifying element operable to discretely regulate said relative humidity of said first fluid flow in a range between about 35% to about 100%.

10. The apparatus of claim 9, wherein said relative humidity of said first fluid flow is selected from the group consisting of: about 36% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, about 90% to about 99%, and combinations thereof.

11. The apparatus of claim 9, further comprising an amount of grain disposed in said vessel, said temperature of said first fluid flow and said relative humidity of said first fluid flow pre-selected to promote germination of said amount of grain.

12. The apparatus of claim 11, wherein said amount of grain is selected from the group consisting of: barley, wheat, corn, rice, rye, oats, sorghum, millet, buckwheat, quinoa, and spelt.

13. The apparatus of claim 9, further comprising a second temperature regulation element operable to discretely regulate the temperature of said second fluid flow generated by said second fluid flow generator.

14. The apparatus of claim 13, wherein said second temperature regulation element operable to discretely regulate the temperature of said second fluid flow in a range between about 50° C. to about 205° C.

15. The apparatus of claim 14, wherein said temperature of said second fluid flow selected from the group consisting of: about 55° C. to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 95° C. to about 105° C., about 100° C. to about 110° C., about 105° C. to about 115° C., about 110° C. to about 120° C., about 115° C. to about 125° C., about 120° C. to about 130° C., about 125° C. to about 135° C., about 130° C. to about 140° C., about 135° C. to about 145° C., about 140° C. to about 150° C., about 145° C. to about 155° C., about 150° C. to about 160° C., about 155° C. to about 165° C., about 160° C. to about 170° C., about 165° C. to about 175° C., about 170° C. to about 180° C., about 175° C. to about 185° C., about 180° C. to about 190° C., about 185° C. to about 195° C., about 190° C. to about 200° C., and about 195° C. to about 204° C., and combinations thereof.

16. The apparatus of claim 11, wherein each of said plurality of first fluid flow generators generates said first fluid flow in a range between about 300 standard cubic feet per minute per ton of grain (scfm/ton) to about 600 scfm/ton.

17. The apparatus of claim 16, wherein said first fluid flow generated by said each of said plurality of first fluid flow generators selected from the group consisting of: about 305 scfm/ton to about 320 scfm/ton, about 310 scfm/ton to about 330 scfm/ton, about 320 scfm/ton to about 340 scfm/ton, about 330 scfm/ton to about 350 scfm/ton, about 340 scfm/ton to about 360 scfm/ton, about 350 scfm/ton to about 370 scfm/ton, about 360 scfm/ton to about 380 scfm/ton, about 370 scfm/ton to about 390 scfm/ton, about 380 scfm/ton to about 400 scfm/ton, about 390 scfm/ton to about 410 scfm/ton, about 400 scfm/ton to about 420 scfm/ton, about 410 scfm/ton to about 430 scfm/ton, about 420 scfm/ton to about 440 scfm/ton, about 430 scfm/ton to about 450 scfm/ton, about 440 scfm/ton to about 460 scfm/ton, about 450 scfm/ton to about 470 scfm/ton, about 460 scfm/ton to about 480 scfm/ton, about 470 scfm/ton to 490 scfm/ton, about 480 scfm/ton to about 500 scfm/ton, about 490 scfm/ton to about 510 scfm/ton, about 500 scfm/ton to about 520 scfm/ton, about 510 scfm/ton to about 530 scfm/ton, about 520 scfm/ton to about 540 scfm/ton, about 530 scfm/ton to about 550 scfm/ton, about 540 scfm/ton to about 560 scfm/ton, about 550 scfm/ton to about 570 scfm/ton, about 560 scfm/ton to about 580 scfm/ton, about 570 scfm/ton to about 590 scfm/ton, about 580 scfm/ton to about 595 scfm/ton, and combinations thereof.

18. The apparatus of claim 16, wherein said second fluid flow generator generates said second fluid flow in a range between at least about 1800 scfm/ton to at least about 3700 scfm/ton.

19. The apparatus of claim 18, wherein said second fluid flow generated by said second fluid flow generator selected from the group consisting of: about 1805 scfm/ton to about 1900 scfm/ton, about 1850 scfm/ton to about 1950 scfm/ton, about 1900 scfm/ton to about 2000 scfm/ton, about 1950 scfm/ton to about 2050 scfm/ton, about 2000 scfm/ton to about 2100 scfm/ton, about 2050 scfm/ton to about 2150 scfm/ton, about 2100 scfm/ton to about 2200 scfm/ton, about 2150 scfm/ton to about 2250 scfm/ton, about 2200 scfm/ton to about 2300 scfm/ton, about 2250 scfm/ton to about 2350 scfm/ton, about 2300 scfm/ton to about 2400 scfm/ton, about 2350 scfm/ton to about 2450 scfm/ton, about 2400 scfm/ton to about 2500 scfm/ton, about 2450 scfm/ton to about 2550 scfm/ton, about 2500 scfm/ton to about 2600 scfm/ton, about 2550 scfm/ton to about 2650 scfm/ton, about 2600 scfm/ton to about 2700 scfm/ton, about 2650 scfm/ton to about 2750 scfm/ton, about 2700 scfm/ton to about 2800 scfm/ton, about 2750 scfm/ton to about 2850 scfm/ton, about 2800 scfm/ton to about 2900 scfm/ton, about 2850 scfm/ton to about 2950 scfm/ton, about 2900 scfm/ton to about 3000 scfm/ton, about 2950 scfm/ton to about 3050 scfm/ton, about 3000 scfm/ton to about 3100 scfm/ton, about 3050 scfm/ton to about 3150 scfm/ton, about 3100 scfm/ton to about 3200 scfm/ton, about 3150 scfm/ton to about 3250 scfm/ton, about 3200 scfm/ton to about 3300 scfm/ton, about 3250 scfm/ton to about 3350 scfm/ton, about 3300 scfm/ton to about 3400 scfm/ton, about 3350 scfm/ton to about 3450 scfm/ton, about 3400 scfm/ton to about 3500 scfm/ton, about 3450 scfm/ton to about 3550 scfm/ton, about 3500 scfm/ton to about 3600 scfm/ton, about 3550 scfm/ton to about 3650 scfm/ton, about 3600 scfm/ton to about 3695 scfm/ton, and combinations thereof.

20. The apparatus of claim 18, further comprising:
a first temperature sensor which senses said temperature of said first fluid flow, said first temperature sensor generating a first temperature sensor signal which varies based on said temperature of said first fluid flow; and
a first temperature controller controlling operation of said first heater element based on said first temperature sensor signal generated by said first temperature sensor, said first temperature controller controlling operation of said first heater element to regulate said temperature of said first fluid flow.

21. The apparatus of claim 20, wherein said first temperature sensor comprises a plurality of first temperature sensors, one of said plurality of first temperature sensors operable to generate a first temperature sensor signal which varies based on said temperature of said first fluid flow.

22. The apparatus of claim 20, further comprising:
a humidity sensor which senses said relative humidity of said first fluid flow in said vessel, said humidity sensor generating a humidity sensor signal which varies based on said relative humidity of said first fluid flow; and
a humidity controller controlling operation of said humidifying element based on said humidity sensor signal generated by said humidity sensor, said humidity controller controlling operation of said humidity element to regulate said relative humidity of said first fluid flow.

23. The apparatus of claim 22, wherein said humidity sensor comprises a plurality of humidity sensors, one of said plurality of humidity sensors operable to generate a relative humidity sensor signal which varies based on said relative humidity of said first fluid flow.

24. The apparatus of claim 23, further comprising:
a second temperature sensor responsive to said temperature of said second fluid flow, said second temperature sensor generating a second temperature sensor signal which varies based on temperature of said second fluid flow; and
a second temperature controller which controls operation of said second temperature regulation element based on said second temperature sensor signal, said second temperature controller controlling operation of said second temperature regulation element to regulate temperature of said second fluid flow.

25. The apparatus of claim 24, further comprising at least one baffle operable to divert said second fluid flow generated by said second fluid generator to said vessel.

26. The apparatus of claim 24, wherein said at least one baffle comprises a plurality of baffles each operable to discretely divert said second fluid flow generated by said second fluid generators to a corresponding one of said plurality of vessels.

27-72. (canceled)
